(19) United States
(12) Patent Application Publication
(10) Pub. No.: US 2014/0256260 A1
(43) Pub. Date: Sep. 11, 2014

(54) Wireless Device Pairing

(71) Applicant: Bose Corporation, Framingham, MA (US)

(72) Inventors: Joji Ueda, Cambrdige, MA (US); Naganagouda B. Patil, Ashland, MA (US); Louis G. Chen, Bolton, MA (US)

(73) Assignee: Bose Corporation, Framingham, MA (US)

(21) Appl. No.: 13/788,797

(22) Filed: Mar. 7, 2013

(51) Int. Cl. H04W 76/02

(52) U.S. Cl. CPC H04W 76/023
USPC 455/41.2

(57) ABSTRACT

A wireless communication network includes a communication source device, such as a Bluetooth digital music player and a communication destination device, such as a Bluetooth headphone or speaker device. The communication source device is configured to transmit audio signals, such as encoded electrical signals in the audio frequency band, to the communication destination device via a wireless or wired audio communication channel. Upon receiving the audio signal, the communication destination device is configured to uniquely identify the communication source device and subsequently enter a discoverable mode to establish a wireless communication channel with the source device, such as via Bluetooth pairing. With such a configuration, the wireless communication channel connection process can be automated requiring little to no user action on either the source or destination device to accomplish the wireless pairing process.

### BACKGROUND

This disclosure relates to wireless communication. Conventionally, wireless communication is utilized in wide ranging applications, such as cellular phone communication and data signal exchange between two or more devices. Certain wireless communication protocols, such as the Bluetooth communication protocol, allow bidirectional communication between a communication destination device, such as a Bluetooth-enabled headset, and a variety of Bluetooth-enabled, computerized endpoint devices, such as cellular phones having Internet capability and additional functionality (e.g., smart phones), laptop computers, and computerized devices configured as panels (e.g., tablet devices).

An example method and apparatus for pairing Bluetooth devices is provided in United States Patent Application Publication 2010/0227549. The Publication recites a simplified apparatus and method for securely pairing Bluetooth and similar radio audio devices by transmitting a PIN value encoded as a tone from an ear bud or speaker of one device to the microphone of the other. The apparatus and method does not require an implementation of the “Simple Secure Pairing” feature on both devices nor do they require the display and operator acceptance of verification values, tones, or computed numeric values.

### SUMMARY

Conventional Bluetooth pairing suffers from a variety of deficiencies. For example, the secure pairing of Bluetooth devices described in the above-referenced Publication utilizes a PIN value encoded as a tone from an ear bud or speaker of one device to the microphone of the other. This transmission of the PIN value is performed in advance of Bluetooth pairing of the devices and is used merely to ensure the identity of the paired units. Following such identification, one of the Bluetooth devices initiates paring with the other device. This process typically involves human action on both devices. For example, on a sink device such as a headphone, a user is typically required to cause the headphone's Bluetooth transceiver to enter the discoverable or pairing mode. On a source device such as a music player, the user is typically required to enter a Bluetooth menu in order to select the intended headphone from a list of devices it discovers within its wireless communication range. Accordingly, this process involves human actions on both devices which are frequently considered to be difficult and confusing to the user.

By contrast to conventional pairings, in one aspect, a communication source device includes an audio transceiver configured to one of send or receive an audio signal to a communication destination device via an audio communication channel, the audio signal including a pairing command configured to initiate establishment of a wireless communication channel between the communication source device and the communication destination device and a wireless transceiver configured, in response to sending the audio signal having the pairing command, to one of (i) receive a communication channel pairing message from the communication destination device, the communication channel pairing message configured to establish the wireless communication channel with the communication source device and (ii) send a communication channel pairing message to the communication destination device to establish the wireless communication channel with the communication destination device.

Embodiments may include one of the following features, or any combination thereof. For example, the audio communication channel can include a wired audio communication channel disposed in electrical communication with the audio transceiver. In such an arrangement, the pairing command is operable to configure the communication destination device to enter a wireless pairing mode to receive the communication channel pairing message from the communication source device. In one arrangement, the audio signal can further include a communication source device address of the communication source device and the pairing command is operable to configure the communication destination device to enter the wireless pairing mode and to receive the communication channel pairing message from the communication source device as identified by the communication source device address. In one arrangement, the audio signal can further include a communication source device address of the communication source device and the pairing command is operable to configure the communication destination device to enter a wireless pairing mode and to transmit the communication channel pairing message to the communication source device as identified by the communication source device address.

In one arrangement, the audio communication channel can include an acoustic communication channel. In such an arrangement, the audio transceiver can include an electroacoustic transducer and the pairing command can include a media access control (MAC) address associated with the communication source device, the MAC address configured to initiate the communication destination device to enter a wireless pairing mode and to transmit the communication channel pairing message to the communication source device. The pairing command of the audio signal is operable to configure the communication destination device to enter a wireless pairing mode and to receive the communication channel pairing message from the communication source device.

In one arrangement, the wireless transceiver is configured to detect a set of wireless pairing mode timestamps associated with a set of communication destination devices and, when sending the communication channel pairing message to the communication destination device to establish the wireless communication channel with the communication destination device, send the communication channel pairing message to a communication destination device of the set of communication destination devices having a timestamp that substantially matches a timestamp associated with the audio signal to establish the wireless communication channel with the communication destination device.

In one arrangement, the wireless transceiver is configured to detect a set of signal strengths associated with a set of communication destination devices, and, when sending the communication channel pairing message to the communication destination device to establish the wireless communication channel with the communication destination device, send the communication channel pairing message to a communication destination device of the set of communication destination devices having the greatest signal strength of the set of signal strengths.

In one arrangement, the wireless transceiver is configured to detect a set of identity indicators associated with a set of communication destination devices, and, when sending the communication channel pairing message to the communication destination device to establish the wireless communication channel with the communication destination device, send the communication channel pairing message to a communication destination device of the set of communication destination devices based upon the identity indicator associated with the communication destination device. In one arrangement, the wireless transceiver is configured to detect a confirmation signal transmitted from the communication destination device in response to transmission of the audio signal by the audio transceiver and the audio transceiver is configured to resend the audio signal to the communication destination device via the audio communication channel, in response to detection of an absence of the confirmation signal from the communication destination device.

In one arrangement, the audio transceiver is configured to, when sending the audio signal to the communication destination device via the audio communication channel, send a first audio signal to the communication destination device via a first audio communication channel, the first audio signal including a first pairing command configured to initiate establishment of the wireless communication channel between the communication source device and the communication destination device and receive a second audio signal from the communication destination device via an audio communication channel, the second audio signal including a second pairing command configured to initiate establishment of a second wireless communication channel between the communication source device and the communication destination device.

In another aspect, a communication destination device includes an audio transceiver configured to one of send or receive an audio signal from a communication source device via an audio communication channel, the audio signal including a pairing command configured to initiate establishment of a wireless communication channel between the communication source device and the communication destination device. The communication destination device includes a wireless transceiver configured, in response to receiving the audio signal having the pairing command, to one of (i) send a communication channel pairing message to the communication source device, the communication channel pairing message configured to establish the wireless communication channel with the communication destination device and (ii) receive a communication channel pairing message from the communication source device to establish the wireless communication channel with the communication source device.

Embodiments may include one of the above and/or below features, or any combination thereof. For example, the audio communication channel can include a wired audio communication channel disposed in electrical communication with the audio transceiver. In such an arrangement, the pairing command is operable to configure the communication destination device to enter a wireless pairing mode to receive the communication channel pairing message from the communication source device. In one arrangement, the audio signal further includes a communication source device address of the communication source device and the pairing command is operable to configure the communication destination device to enter the wireless pairing mode and to receive the communication channel pairing message from the communication source device as identified by the communication source device address. In one arrangement, the audio signal further includes a communication source device address of the communication source device and the pairing command is operable to configure the communication destination device to enter a wireless pairing mode and to transmit the communication channel pairing message to the communication source device as identified by the communication source device address.

In one arrangement of the communication destination device, the audio communication channel includes an acoustic communication channel and the audio transceiver includes a microphone. In one arrangement, the pairing command includes a media access control (MAC) address associated with the communication source device, the MAC address configured to initiate the communication destination device to enter a wireless pairing mode and to transmit the communication channel pairing message to the communication source device.

In one arrangement, the pairing command of the audio signal is operable to configure the communication destination device to enter a wireless pairing mode and to receive the communication channel pairing message from the communication source device. In one arrangement, the wireless transceiver is configured to provide a wireless pairing mode timestamp associated with the communication destination devices and, when receiving the communication channel pairing message from the communication source device to establish the wireless communication channel with the communication source device, receive the communication channel pairing message when the communication destination device has a wireless pairing mode timestamp that substantially matches a timestamp associated with the audio signal to establish the wireless communication channel with the communication source device.

In one arrangement, the wireless transceiver is configured to provide a signal strength associated with the communication destination device and, when receiving the communication channel pairing message from the communication source device to establish the wireless communication channel with the communication source device, receive the communication channel pairing message from the communication source device when the signal strength provided by the communication destination device is greater than a signal strength associated with a second communication destination device.

In one arrangement, the wireless transceiver is configured to provide an identity indicator associated with the communication destination device and, when receiving the communication channel pairing message from the communication source device to establish the wireless communication channel with the communication source device, receive the communication channel pairing message from the communication source device based upon the identity indicator associated with the communication destination device.

In one arrangement, the wireless transceiver is configured to provide a confirmation signal to the communication source device in response to reception of the audio signal by the microphone and the microphone is configured to receive a second audio signal from the communication source device via the audio communication channel in response to detection, by the communication source device, of an absence of the confirmation signal from the communication destination device.

In one arrangement, the audio transceiver is configured to, when receiving the audio signal from the communication source device via the audio communication channel, receive a first audio signal from the communication source device via a first audio communication channel, the first audio signal including a first pairing command configured to initiate establishment of the wireless communication channel between the communication destination device and the communication source device. The audio transceiver is also configured to send a second audio signal to the communication source device via an audio communication channel, the second audio signal including a second pairing command configured to initiate establishment of a second wireless communication channel between the communication destination device and the communication source device.

In one arrangement, the audio transceiver is configured to one of send or receive the audio signal, including the pairing command, in response to a power activation activity associated with the communication destination device. In one arrangement, the audio transceiver is configured to one of send or receive the audio signal, including the pairing command, in response to a disconnection from the previously-paired communication source device.

In another aspect, in a communication source device, a method of establishing a wireless communication channel with a communication destination device includes sending, by the communication source device, an audio signal to the communication destination device via an audio communication channel, the audio signal including a pairing command configured to initiate establishment of the wireless communication channel between the communication source device and the communication destination device. The method includes, in response to sending the audio signal having the pairing command, one of (i) receiving, by the communication source device, a communication channel pairing message from the communication destination device, the communication channel pairing message configured to establish the wireless communication channel with the communication source device and (ii) sending, by the communication source device, a communication channel pairing message to the communication destination device to establish the wireless communication channel with the communication destination device.

In another aspect, in a communication destination device, a method of establishing a wireless communication channel with a communication source device, includes receiving, by the communication destination device, an audio signal from the communication source device via an audio communication channel, the audio signal including a pairing command configured to initiate establishment of the wireless communication channel between the communication source device and the communication destination device. The method includes in response to receiving the audio signal having the pairing command, one of (i) sending, by the communication destination device, a communication channel pairing message to the communication source device, the communication channel pairing message configured to establish the wireless communication channel with the communication destination device and (ii) receiving, by the communication destination device, a communication channel pairing message from the communication source device to establish the wireless communication channel with the communication source device.

All examples and features mentioned above can be combined in any technically possible way.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates a wireless communication network, according to one arrangement.

FIG. 2 illustrates the wireless communication network of FIG. 1 having a wireless audio communication channel disposed between a communication source device and a communication destination device, according to one arrangement.

FIG. 3 illustrates the wireless communication network of FIG. 1 having a communication source device and a plurality of communication destination devices disposed in electrical communication there with, according to one arrangement.

FIG. 4 illustrates the wireless communication network of FIG. 1 having a two-way wireless communication channel, according to one arrangement.

FIG. 5 illustrates the wireless communication network of FIG. 1 having an acoustic communication channel disposed between a communication destination device and a communication source device, according to one arrangement.

### DETAILED DESCRIPTION

Embodiments of a wireless communication network simplify the initial pairing process between a communication source device, such as a Bluetooth digital music player and a communication destination device, such as a Bluetooth headphone or speaker device. The communication source device is configured to transmit audio signals, such as encoded electrical signals in the audio frequency band or acoustic signals output by an electro-acoustic transducer, to the communication destination device via a wireless or wired audio communication channel. Upon receiving the audio signal, the communication destination device is configured to uniquely identify the communication source device and subsequently enter a discoverable mode to establish a wireless communication channel with the source device, such as via Bluetooth pairing. With such a configuration, the wireless communication channel connection process can be automated requiring little to no user action on either the source or destination device to accomplish the wireless pairing process.

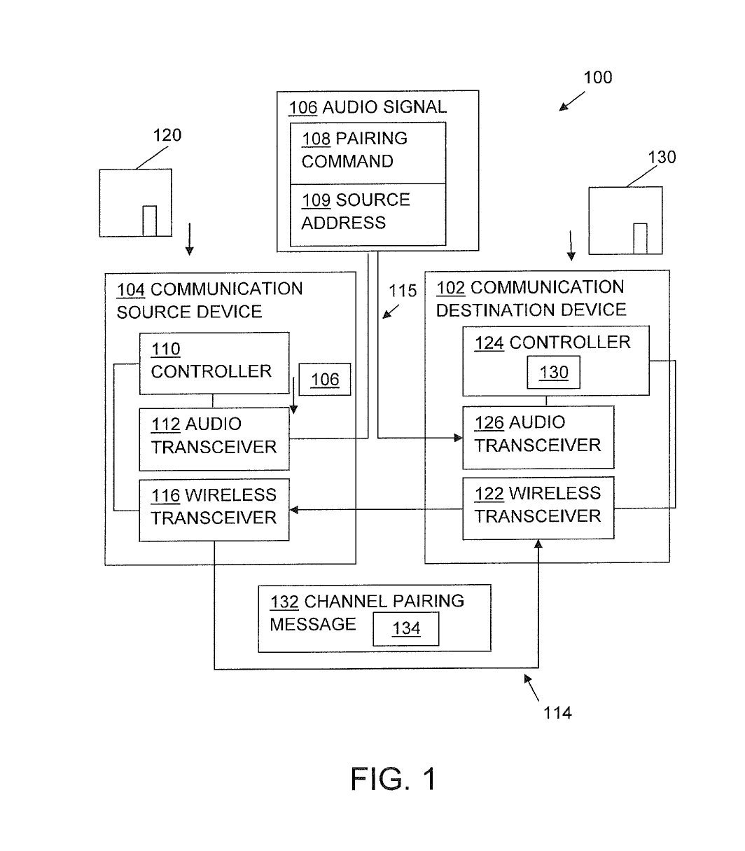

FIG. 1 illustrates a wireless communication network 100, according to one arrangement. The wireless communication network 100 includes a communication destination device 102 and a communication source device 104 disposed in wireless communication with each other. While the wireless communication network 100 can be configured in a variety of ways, in one arrangement the wireless communication network 100 is configured as a set of point-to-point links using the Bluetooth wireless communication technology. In this arrangement, each of the communication destination device 102 and communication source device 104 is configured as a Bluetooth-enabled device and is operable to communicate using a set of Bluetooth protocols.

In one arrangement, the communication source device 104 is a computerized device configured as an audio source device, such as a Bluetooth-enabled tablet device (e.g., iPad™), digital music player device (e.g., MP3 file player, iPod™), mobile smart phone device (e.g., iPhone™), or other computerized device. The communication source device 104 is configured to exchange wireless communications with the communication destination device 102 via a wireless communication channel 114. For example, the communication source device 104 includes a wireless transceiver 116 configured to establish the wireless communication channel 114 with communication destination device 102. In one arrangement, the wireless communication channel 114 is configured as a Bluetooth channel that exchanges messages based upon particular Bluetooth-based wireless communication protocols. Establishment of the wireless communication channel 114 with the communication destination device 102 allows the communication source device 104 to stream audio content to the destination device 102 via the wireless transceiver 116 utilizing the standardized A2DP, for example.

To initiate establishment of the wireless communication channel 114, the communication source device 104 is configured to generate an audio signal 106 that includes a pairing command 108 and provide the signal 106 to the communication destination device 102. In one arrangement, the communication source device 104 includes a controller 110, such as a memory and processor, disposed in electrical communication with an audio transceiver 112. The controller 110 is configured to generate the audio signal 106 and the audio transceiver 112 is configured to deliver the audio signal 106 to the communication destination device 102 via an audio communication channel 115. For example, the controller 110 can generate the audio signal 106 as an acoustic signal having a particular set of audio tones (e.g., the notes C, E, and G) either played in series, as an arpeggio or other musical phrase, or in a substantially continuous manner, such as a chord. In such a case, the audio tones and the sequential or simultaneous execution of the tones operate as the pairing command 108. In another example, the controller 110 can generate the audio signal 106 as an ultrasonic signal transmitted either acoustically or electrically to the destination device 102. In another example, the controller 110 can generate the audio signal 106 as an electrical signal having an embedded code, such as a modulated signal portion, that operates as the pairing command 108. As will be discussed below, in response to receiving the pairing command 108 via the audio signal 106, the communication destination device 102 can engage in the establishment of the wireless communication channel 114.

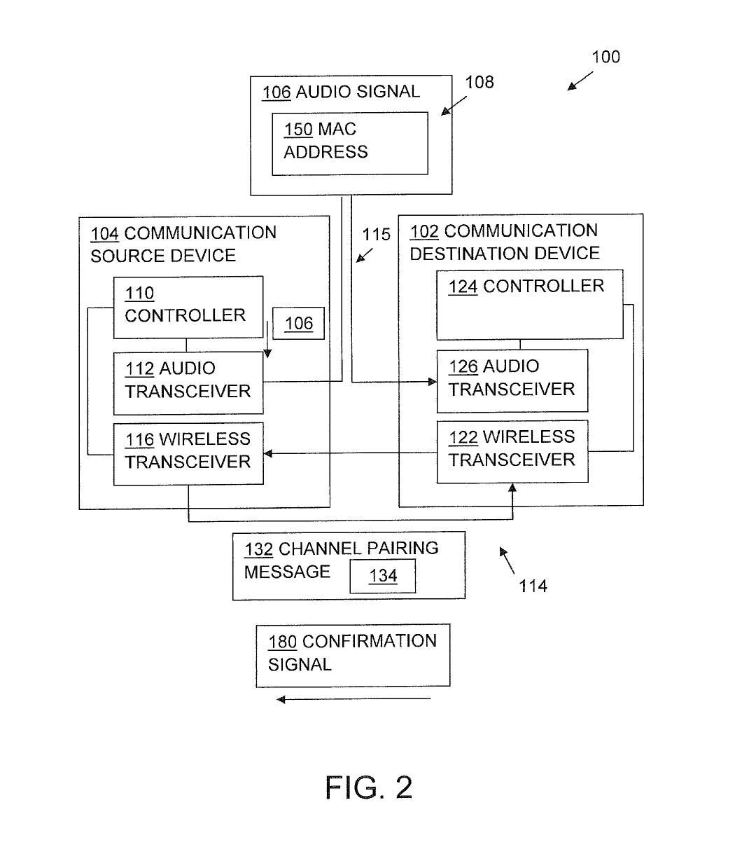

The audio transceiver 112 can be configured in a variety of ways, depending upon the type of audio signal 106 to be provided to the communication destination device 102. In one arrangement, with reference to FIG. 2, the audio communication channel 115 is configured as an acoustic communication channel 115 and the audio transceiver 112 is configured as an electroacoustic transducer, such as a loudspeaker, that provides the audio signal 106 as an acoustic signal to the communication destination device 102 via the channel 115. In one arrangement, returning to FIG. 1, the audio communication channel 115 is configured as a wired audio communication channel 115, such as a cable, and the audio transceiver 112 is configured as an audio hardware device, such as a headphone jack, that electrically communicates with the communication destination device 102 via the channel 115.

In one arrangement, the controller 110 stores a pairing application that, when executed by the controller 110, causes the controller 110 to perform the operations of generating and initiating the audio transceiver 112 to transmit the audio signal 106 including the pairing command 108. The pairing application installs on the communication source device 104 from a computer program product 120. In certain arrangements, the computer program product 120 is available in a standard off-the-shelf form such as a shrink wrap package (e.g., CD-ROMs, diskettes, tapes, etc.). In other arrangements, the computer program product 120 is available in a different form (e.g., propagated signals, a network installation, purchasable and downloadable online media, etc.). In still other arrangements, the computer program product 120 is part of a storage medium contained within the communication source device 104 as part of a memory from which such software may be loaded.

In one arrangement, the communication destination device 102 is configured as an audio sink device or a hands free (i.e., wireless) Bluetooth headset device. The communication destination device 102 is configured to exchange wireless communications with the communication source device 104 via the wireless communication channel 114. For example, the communication destination device 102 includes a wireless transceiver 122 configured to establish the wireless communication channel 114 with communication source device 104.

The communication destination device 102 is configured to establish the wireless communication channel 114 with the communication source device 104 in response to receiving the pairing command 108 of the audio signal 106. In one arrangement, the communication destination device 102 includes a controller 124, such as a memory and processor, disposed in electrical communication with an audio transceiver 126. The audio transceiver 126 is configured to receive the audio signal 106 from the communication source device 104. The audio transceiver 126 can be configured in a variety of ways and can correspond to the type of audio signal 106 transmitted from the communication source device 104. For example, the audio transceiver 126 can be configured as a transducer, such as a microphone, to receive the audio signal 106 as a wireless acoustic signal from the communication source device 104. In another example, the audio transceiver 126 is configured as an audio hardware device, such as a headphone jack, to receive the audio signal 106 from the communication source device 104 via a wired connection, such as a cable.

In response to the audio transceiver 126 receiving the audio signal 106, the controller 124 is configured to detect the presence or absence of the pairing command 108 with respect to the audio signal 106. For example, in the case where the audio transceiver 126 receives an acoustic signal as the audio signal 106 via the audio channel 115, the controller 124 is configured to detect the audio signal 106 as having a particular set of audio tones either played in series or in a substantially continuous manner. In the case where the acoustic pattern of the audio signal 106 corresponds to a preconfigured acoustic pattern, such as stored in memory, the controller 124 can detect the audio signal 106 as including a pairing command 108. As a result, the controller 124 can activate the wireless transceiver 122 to engage in establishment of the wireless communication channel 114 with the communication source device 104.

In one arrangement, the controller 124 stores a pairing application that, when executed by the controller 124, causes the controller 124 to perform the operation of detecting the presence or absence of a pairing command 108 associated with the audio signal 106. The pairing application installs on the communication destination device 102 from a computer program product 130. In certain arrangements, the computer program product 130 is available in a standard off-the-shelf form such as a shrink wrap package (e.g., CD-ROMs, diskettes, tapes, or flash drives). In other arrangements, the computer program product 130 is available in a different form (e.g., propagated signals, a network installation, or downloadable online media). In still other arrangements, the computer program product 130 is part of a storage medium contained within the communication destination device 102 as part of a memory from which such software may be loaded.

In use, the communication source device 104 and the communication destination device 102 operate in conjunction with each other to establish the wireless communication channel 114, such as for streaming of audio content from the communication source device 104 to the destination device 102. As indicated above, the devices 104, 102 can utilize either a wired or acoustic communication channel 115 to initiate the wireless pairing process via the wireless channel. For the following description, assume the case of wired audio communication channel 115 disposed in electrical communication between the respective audio transceivers 112, 126.

During operation, the controller 110 generates an audio signal 106 that includes a pairing command 108, such as an embedded code or modulated signal portion, as well as a source address 109, and forwards the audio signal 106 to the audio transceiver 112. As will be described below, the source address 109 can allow the destination device 102 to identify the communication source device 104 during the establishment of the wireless communication channel 114. While the source address 109 can be configured in a variety of ways, in one arrangement, the source address 109 is configured as a model and/or serial number associated with the communication source device 104. The audio transceiver 112, such as an audio hardware device, then transmits the audio signal 106 to the audio transceiver 126 of the communication destination device 102 via the wired audio communication channel 115.

Upon receipt of the audio signal 106, the audio transceiver 126 provides the audio signal 106 to the controller 124 which then decodes or extracts the pairing command 108 from the audio signal 106. In one arrangement, to verify the paring command 108 once extracted, the controller 124 can compare the pairing command 108 to a preset or preconfigured identifier 130. In the case where the controller 124 detects a correspondence between the pairing command 108 and the preset identifier 130, the controller 124 can trigger the wireless transceiver 122 of the communication destination device 102 to enter a wireless pairing mode. As will be described below, the pairing mode allows for the establishment of the wireless communication channel 114 between the communication source device 104 and the communication destination device 102. In the case where the controller 124 detects a lack of correspondence between the pairing command 108 and the preset identifier 130, the controller 124 can drop the audio signal 106 and refrain from triggering the wireless transceiver 122 of the communication destination device 102 to enter the wireless pairing mode.

In one arrangement, once the communication destination device 102 enters the wireless pairing or discoverable mode, the destination device 102 is configured to await further pairing protocol communication from the communication source device 104 to establish the wireless communication channel 114. For example, with such a configuration, the wireless transceiver 116 of the communication source device 104 can send a communication channel pairing message 132 to the wireless transceiver 122 of communication destination device to establish the wireless communication channel 114 with the communication destination device 102.

The communication destination device 102 can be configured to only respond to the pairing protocol or channel pairing message 132 originating from the unique communication source device 104. In one arrangement, in response to receiving the channel pairing message 132 from the communication source device 104, the communication destination device 102 is configured to confirm the identity of the source device 104 based upon the earlier-received source address 109, as provided via the wired communication channel 115. For example, after the transceiver 122 receives the channel pairing message 132, the controller 124 of the communication destination device 102 compares a source device identifier 134 of the channel pairing message 132 with the source address 109. In the case where the controller 124 detects a correspondence between the source device identifier 134 and the source address 109, the controller 124 can signal or otherwise instruct the wireless transceiver 122 to proceed with pairing with the communication source device 102. In the case where the controller 124 detects a lack of correspondence between the source device identifier 134 and the source address 109, the controller 124 can signal or otherwise instruct the wireless transceiver 122 to discontinue the pairing process with the communication source device 104.

In another arrangement, once the communication destination device 102 enters the wireless pairing mode, the destination device 102 can be configured to initiate communication with the communication source device 104 to establish the wireless communication channel 114. With such a configuration, the wireless transceiver 122 of the communication destination device 102 can send a communication channel pairing message 132 to the wireless transceiver 116 of communication source device 104 to establish the wireless communication channel 114 with the communication source device 104. For example, the communication destination device 102 reviews the previously received source address 109 to identify the communication source device 104. Once identified, the communication destination device 102 forwards the communication channel pairing message 132 to the communication source device 104 based upon the source address 109. The communication channel pairing message 132 configures the source device 104 to enter a discoverable or pairing mode, such as a Bluetooth discoverable or pairing mode. In one arrangement, the communication channel pairing message 132 includes an address 134, such as a Bluetooth address, of the communication destination device 102, which allows the communication source device 104 to identify the communication destination device 102 during the pairing process.

As a result of the transmission of the communication channel pairing message 132, either from the communication source device 104 or from the communication destination device 102, the devices 104, 102 establish the wireless communication channel 114 with each other. For example, the Bluetooth-enabled headset 102 can establish a Bluetooth channel 114 with a Bluetooth-enabled smart phone 104 via a conventional Bluetooth pairing mechanism. As a result of the pairing, the headset 102 and smart phone 104 are configured to communicate with each other using the Bluetooth Hands-Free Profile and the Headset Profile, among others.

With such a configuration, the wireless communication channel connection process can be automated between the communication source and destination devices 104, 102. Accordingly, the process requires relatively little to no user action on either the source or destination device 104, 102 to accomplish the wireless pairing process.

As indicated above, the devices 104, 102 can utilize either a wired or acoustic communication channel 115 to initiate the wireless pairing process via the wireless channel. For the following description, assume the case where an acoustic communication channel 115 disposed in electrical communication between the respective audio transceivers 112, 126, as illustrated in FIG. 2. In such an arrangement, the audio transceiver 112 of the communication source device 104 is configured as an electroacoustic transducer or loudspeaker and the audio transceiver 126 of the communication destination device 102 is configured as a microphone. Here, the loudspeaker or ringer transducer 112 of the communication source device 104 outputs an audio frequency signal or acoustic signal 106 and the microphone 122 of the communication destination device 102 attempts to receive this acoustic signal 106.

During operation, a user places the communication source device 104 in relatively close proximity to the communication destination device 102 and activates the communication source device 104. In response, the controller 110 generates an audio signal 106 that includes an encoded pairing command 108, such as a media access control (MAC) address 150 associated with the communication source device 104, and forwards the audio signal 106 to the audio transceiver 112. The MAC address 150 is configured to initiate the communication destination device 102 to enter a wireless pairing mode. The audio transceiver 112 then emits the audio signal 106 to the audio transceiver 126 of the communication destination device 102 via the wired audio communication channel 115. In one arrangement, the duration of the audio signal 106 is relatively short and the inclusion of the encoded MAC address 150 as part of the audio signal 106 is substantially undetectable by a user.

The communication destination device 102 can be configured to receive the acoustic audio signal 106 in a variety of situations. In one arrangement, the communication destination device 102 is configured to receive the audio signal 106 and pairing command 108, such as for a fix period of time, in response to a power activation activity associated with the communication destination device 102 (e.g., every time the power of the device 102 is activated by a user). In one arrangement, the communication destination device 102 is configured to receive the audio signal 106 and pairing command 108 in response to a disconnection from the previously-paired communication source device 104.

Upon receipt of the audio signal 106, the audio transceiver 126 provides the audio signal 106 to the controller 124 which then decodes the audio signal 106 and extracts the MAC address 150 communication source device 104. In one arrangement, using the MAC address 150 of the communication source device 104, the wireless transceiver 122 enters a pairing mode and, in one arrangement, initiates a targeted pairing to the communication source device 104 by transmitting the channel pairing message 132 to the communication source device 104. In another arrangement, as a result of receiving the MAC address 150, the communication destination device 102 enters a pairing mode, such as a Bluetooth discoverable mode waits for the communication source device 104 to initiate the pairing process via the channel pairing message 132.

With such a configuration, the wireless communication channel connection process can be automated between the communication source and destination devices 104, 102.

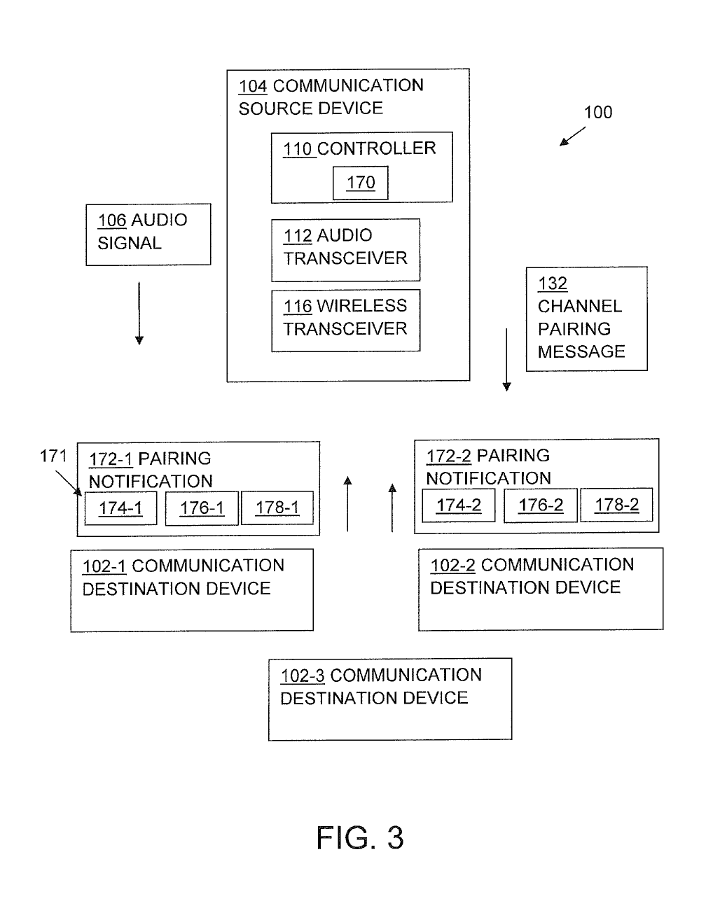

In certain situations, the communications source device 104 can be disposed in proximity to multiple communication destination devices 102. As will be described below and with reference to FIG. 3, the communication source device 104 is configured to distinguish a particular target communication destination device 102 for establishment of the wireless communication channel 114 based upon a wireless pairing mode identifier 171 provided by the communication destination devices 102.

In one arrangement, the communications source device 104 is configured to differentiate a desired communication destination device 102 from other discoverable devices 102 in its range by detecting the device 102 that becomes discoverable a relatively short period of time after broadcast of the acoustic audio signal 106. For example, with reference to FIG. 3, assume the case where the communication source device 104 broadcasts the acoustic audio signal 106 to a set of communication destination devices 102-1 through 102-3. As part of the broadcast transmission process, the communications source device 104 creates a timestamp 170, such as a date and time of transmission, and stores the timestamp 170 in the controller 110. Following reception of the transmitted audio signal 106, more than one of the set of communication destination devices 102-1 through 102-3 can generate and forward a corresponding pairing notification 150 to the communication source device 104. For example, assume that in response to receiving the audio signal 106, a first and second communication destination device 102-1, 102-2 each generate a corresponding pairing notification 172-1, 172-2. The pairing notifications 172-1, 172-2 are configured to notify the communication source device 104 of the ability for the first and second communication destination devices 102-1, 102-2 to enter into pairing mode. Additionally, each of the pairing notifications 172-1, 172-2 includes a corresponding wireless pairing mode timestamp 174-1, 174-2 which identifies the date and time that the first and second communication destination devices 102-1, 102-2 became available to enter pairing mode.

As the communication source device 104 receives the pairing notification 172-1, 172-2, the device 104 compares the associated wireless pairing mode timestamp 174-1, 174-2 with the timestamp 170 stored in the controller 110 to detect the communication destination device 102-1, 102-2 that became available for pairing first. Assume the second communication destination device 102-2 was available for pairing before the first communication destination device 102-1. In this case, after comparing the wireless pairing mode timestamps 174-1, 174-2 with the timestamp 170, the communication source device 104 can detect the stored timestamp 170 as substantially matching the second wireless pairing mode timestamp 174-2 (i.e., as being closer in time relation than the first wireless pairing mode timestamp 174-2). In such a case, the communication source device 104 sends the communication channel pairing message 138 to the second communication destination device 102-2 to establish the wireless communication channel 114 with the second communication destination device 102-2 and to minimize wireless channel connections 114 with multiple destination devices 102.

In one arrangement, the communications source device 104 is configured to differentiate a desired communication destination device 102 from other discoverable devices 102 in its range based upon a signal strength 176 associated with the pairing notification 172. For example, as the communication source device 104 receives pairing notifications 172-1, 172-2, the communication source device 104 detects and compares the signal strengths 176-1, 176-2 associated with the corresponding communication destination devices 102-1, 102-2. Based upon the comparison, the communication source device 104 forwards the communication channel pairing message 132 to the communication destination device 102-1, 102-2 having the relatively stronger or greater signal strength 176 of the set of signal strengths 176-1, 176-2.

In one arrangement, the communications source device 104 is configured to differentiate a desired communication destination device 102 from other discoverable devices 102 in its range based upon an identity indicator 178, such as the Bluetooth address of the destination devices 102, associated with the pairing notification 172. The communications source device 104 can utilize the Bluetooth address to discern the manufacturer of each destination device 102. For example, as the communication source device 104 receives pairing notifications 172-1, 172-2, the communication source device 104 detects the identity indicators 178-1, 178-2 associated with a set of communication destination devices 102-1, 102-2. Based upon the detected identity of the communication destination devices 102-1, 102-2 (e.g., brand X versus brand Y), the communications source device 104 can be configured to send the communication channel pairing message 132 to a particular communication destination device 102-1, 102-2 2 to establish the wireless communication channel 114.

Returning to FIG. 2, during operation, the communication source device 104 can generate and transmit the acoustic audio signal 106 in a relatively noisy environment. Such transmission can cause the communication destination device 102 to improperly or erroneously decode the audio signal 106. To minimize these types of errors, in one arrangement, the communication source and destination devices 104, 102 can be configured with an error detection mechanism that aids the communication destination device 102 in decoding the audio signal 106 in a relatively noisy environment. In one arrangement, source is configured with error detection to aid the sink in decoding the pairing command.

For example, following reception of the acoustic audio signal 106, the wireless transceiver 122 of the communication destination device 102 is configured to transmit a confirmation signal 180 to the communication source device 104. Transmission of the confirmation signal 180 notifies the communication source device 104 as to the reception of a complete and substantially error-free acoustic audio signal 106. In the absence of receipt of the confirmation signal 180 after a given timeframe, the communication source device 104 can determine that the communication destination device 102 failed to receive the acoustic audio signal 106 in a substantially error-free format. As a result, the audio transceiver 112 of the communication source device 104 is configured to resend the acoustic audio signal 106 to the communication destination device 102 via the audio communication channel 115.

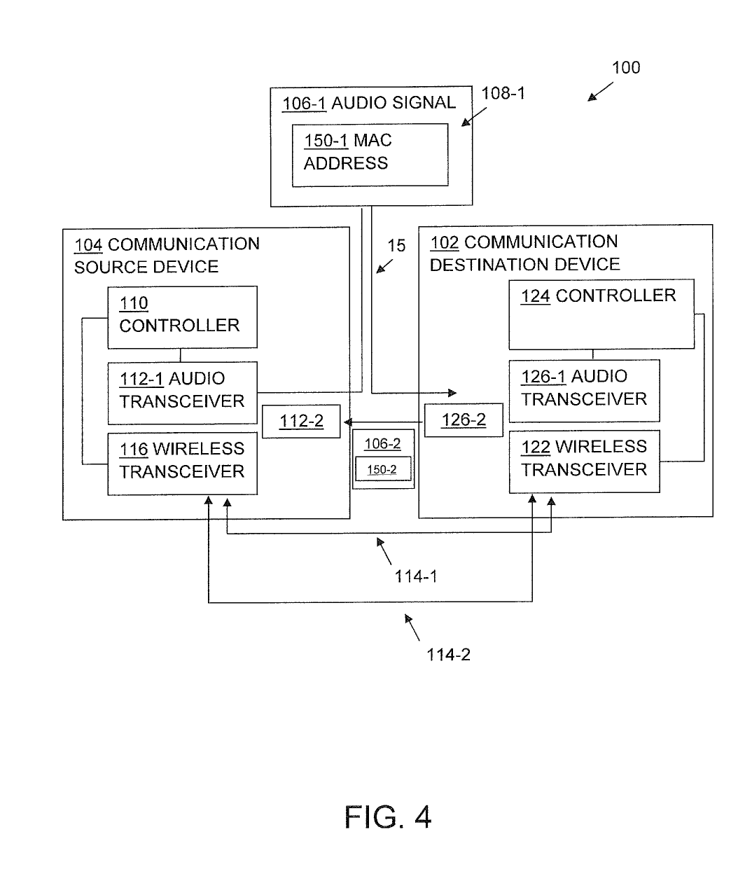

As indicated above, the communication source device 104 is configured to generate and transmit the acoustic audio signal 106 via a transducer 112 and the communication destination device 102 is configured to receive the acoustic audio signal 106 via a microphone 126. Transmission of the acoustic audio signal 106 initiates the establishment of a wireless communication channel 114. Such description is by way of example only. In one arrangement, and with reference to FIG. 4, both the communication source device 104 and the communication destination device 102 is configured to generate and transmit acoustic audio signals 106-1, 106-2 to establish two-way communication between the devices 104, 102.

For example, the communication source device 104 includes a first audio transceiver 112-1, such as a speaker, configured to generate the first audio signal 106-1 in order to initiate establishment of a first wireless communication channel 114-1 between the communication source device 104 and the communication destination device 102. Additionally, the communication destination device 102, such as a wireless headphone, is configured to generate its own encoded acoustic signal 106-2 through its transducer (e.g., speaker) 126-2 at any time during this process. This acoustic signal 106-2 can in turn be received by a second audio transceiver 112-2, such as a microphone, of the communication source device 104 to establish a second wireless communication channel 114-2 between the communication source device 104 and the communication destination device 102. The two-way wireless communication channel 114-1, 114-2 aids in the pairing of the two devices 104, 102 via standardized wireless signal or protocols.

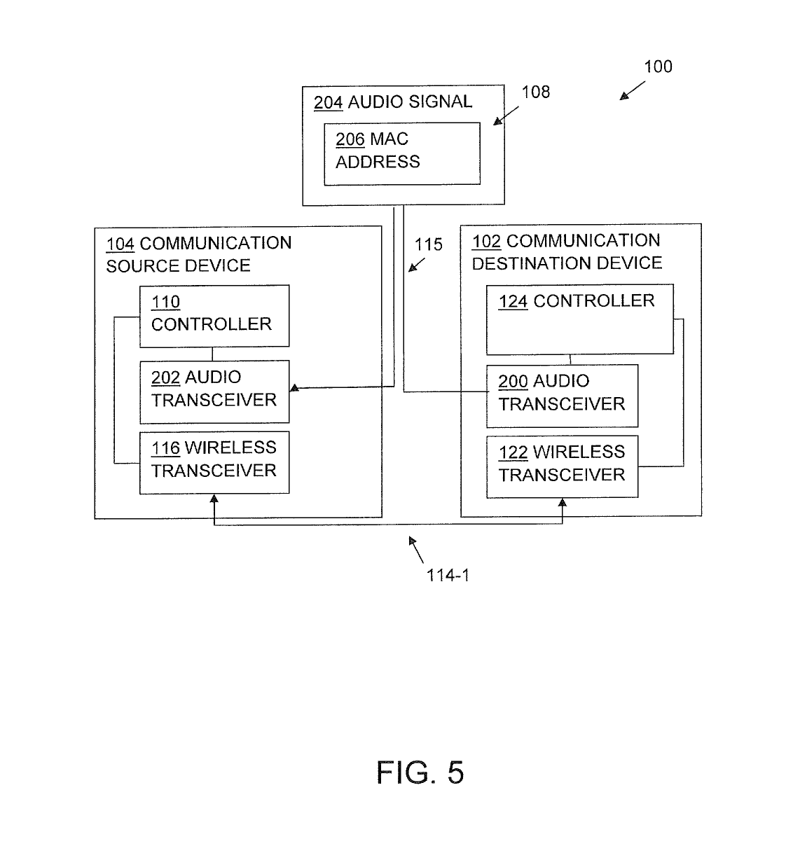

As indicated above, the communication source device 104 is configured to generate and transmit the acoustic audio signal 106 via a transducer 112 and the communication destination device 102 is configured to receive the acoustic audio signal 106 via a microphone 126. Such description is by way of example only. With reference to FIG. 5, in one arrangement, the communication destination device 102 includes an audio transceiver 200, such as a speaker, configured to generate and transmit an acoustic audio signal 204 having a pairing command 108, such as a MAC address 206. In turn, the communication source device 104 is configured to receive the acoustic audio signal 200 via an audio transceiver 202 such as a microphone and decode the MAC address 206.

For example, during operation, a user can place the communication destination device 102, such as a headset or a speaker, within relatively close proximity (e.g., within about one inch distance from) the communication source device 104, such as a smart phone or a tablet. Upon being powered-up or activated, the controller 124 of the communication destination device 102 takes the MAC address of the communication destination device 102, which is unique to each communication destination device 102 and embeds the MAC address into an audio signal 204. The audio transceiver 200 then emits the acoustic audio signal 204 embedded with the MAC address of the device 102. While the acoustic audio signal 204 can be configured in a variety of ways, in one arrangement, the audio signal 204 is an audio power-up signal have a relatively short duration or is provided in the form of one or more musical chords, audible to users. With the audio signal 204 being encoded with the MAC address 206 and audible to users, in one arrangement, inclusion of the MAC address 206 does not affect or only minimally affect the sound quality of the audio signal 204.

After the audio transceiver 202 receives the acoustic audio signal 204, the controller 110 of the communication source device 104 decodes the audio signal 106 and extracts the MAC address 206 of the communication destination device 102. Using the MAC address 206 of the communication destination device 102, the controller 110 causes the wireless transceiver 116 to initiate establishment of the wireless communication channel 114 with the communication destination device 102, either by transmitting or receiving a communication channel pairing message relative to the communication destination device 102.

Embodiments of the systems and methods described above comprise computer components and computer-implemented steps that will be apparent to those skilled in the art. For example, it should be understood by one of skill in the art that the computer-implemented steps may be stored as computer-executable instructions on a computer-readable medium such as, for example, floppy disks, hard disks, optical disks, Flash ROMS, nonvolatile ROM, and RAM. Furthermore, it should be understood by one of skill in the art that the computer-executable instructions may be executed on a variety of processors such as, for example, microprocessors, digital signal processors, gate arrays, etc. For ease of exposition, not every step or element of the systems and methods described above is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the disclosure.

A number of implementations have been described. Nevertheless, it will be understood that additional modifications may be made without departing from the scope of the inventive concepts described herein, and, accordingly, other embodiments are within the scope of the following claims.

What is claimed is:

1. A communication source device, comprising:
an audio transceiver configured to one of send or receive an audio signal to a communication destination device via an audio communication channel, the audio signal including a pairing command configured to initiate establishment of a wireless communication channel between the communication source device and the communication destination device; and
a wireless transceiver configured, in response to sending the audio signal having the pairing command, to one of:
(i) receive a communication channel pairing message from the communication destination device, the communication channel pairing message configured to establish the wireless communication channel with the communication source device, and
(ii) send a communication channel pairing message to the communication destination device to establish the wireless communication channel with the communication destination device.

2. The communication source device of claim 1, wherein the audio communication channel comprises a wired audio communication channel disposed in electrical communication with the audio transceiver.

3. The communication source device of claim 2, wherein the pairing command is operable to configure the communication destination device to enter a wireless pairing mode to receive the communication channel pairing message from the communication source device.

4. The communication source device of claim 3, wherein, when sending the audio signal:
the audio signal further comprises a communication source device address of the communication source device; and
the pairing command is operable to configure the communication destination device to enter the wireless pairing mode and to receive the communication channel pairing message from the communication source device as identified by the communication source device address.

5. The communication source device of claim 2, wherein, when sending the audio signal:
the audio signal further comprises a communication source device address of the communication source device; and
the pairing command is operable to configure the communication destination device to enter a wireless pairing mode and to transmit the communication channel pairing message to the communication source device as identified by the communication source device address.

6. The communication source device of claim 1, wherein:
the audio communication channel comprises an acoustic communication channel; and
the audio transceiver comprises an electroacoustic transducer.

7. The communication source device of claim 6, wherein the pairing command comprises a media access control (MAC) address associated with the communication source device, the MAC address configured to initiate the communication destination device to enter a wireless pairing mode and to transmit the communication channel pairing message to the communication source device.

8. The communication source device of claim 6, wherein the pairing command of the audio signal is operable to configure the communication destination device to enter a wireless pairing mode and to receive the communication channel pairing message from the communication source device.

9. The communication source device of claim 8, wherein the wireless transceiver is configured to:
detect a set of wireless pairing mode timestamps associated with a set of communication destination devices; and
when sending the communication channel pairing message to the communication destination device to establish the wireless communication channel with the communication destination device, send the communication channel pairing message to a communication destination device of the set of communication destination devices having a timestamp that substantially matches a timestamp associated with the audio signal to establish the wireless communication channel with the communication destination device.

10. The communication source device of claim 8, wherein the wireless transceiver is configured to:
detect a set of signal strengths associated with a set of communication destination devices; and
when sending the communication channel pairing message to the communication destination device to establish the wireless communication channel with the communication destination device, send the communication channel pairing message to a communication destination device of the set of communication destination devices having the greatest signal strength of the set of signal strengths.

11. The communication source device of claim 8, wherein the wireless transceiver is configured to:
detect a set of identity indicators associated with a set of communication destination devices; and
when sending the communication channel pairing message to the communication destination device to establish the wireless communication channel with the communication destination device, send the communication channel pairing message to a communication destination device of the set of communication destination devices based upon the identity indicator associated with the communication destination device.

12. The communication source device of claim 8, wherein:
the wireless transceiver is configured to detect a confirmation signal transmitted from the communication destination device in response to transmission of the audio signal by the audio transceiver; and
the audio transceiver is configured to resend the audio signal to the communication destination device via the audio communication channel, in response to detection of an absence of the confirmation signal from the communication destination device.

13. The communication source device of claim 6, wherein the audio transceiver is configured to:
when sending the audio signal to the communication destination device via the audio communication channel, send a first audio signal to the communication destination device via a first audio communication channel, the first audio signal including a first pairing command configured to initiate establishment of the wireless communication channel between the communication source device and the communication destination device; and
receive a second audio signal from the communication destination device via an audio communication channel, the second audio signal including a second pairing command configured to initiate establishment of a second wireless communication channel between the communication source device and the communication destination device.

14. A communication destination device, comprising:
an audio transceiver configured to one of send or receive an audio signal from a communication source device via an audio communication channel, the audio signal including a pairing command configured to initiate establishment of a wireless communication channel between the communication source device and the communication destination device; and
a wireless transceiver configured, in response to receiving the audio signal having the pairing command, to one of:
(i) send a communication channel pairing message to the communication source device, the communication channel pairing message configured to establish the wireless communication channel with the communication destination device, and
(ii) receive a communication channel pairing message from the communication source device to establish the wireless communication channel with the communication source device.

15. The communication destination device of claim 14, wherein the audio communication channel comprises a wired audio communication channel disposed in electrical communication with the audio transceiver.

16. The communication destination device of claim 15, wherein the pairing command is operable to configure the communication destination device to enter a wireless pairing mode to receive the communication channel pairing message from the communication source device.

17. The communication destination device of claim 16, wherein, when sending the audio signal:
the audio signal further comprises a communication source device address of the communication source device; and
the pairing command is operable to configure the communication destination device to enter the wireless pairing mode and to receive the communication channel pairing message from the communication source device as identified by the communication source device address.

18. The communication destination device of claim 15, wherein, when sending the audio signal:
the audio signal further comprises a communication source device address of the communication source device; and
the pairing command is operable to configure the communication destination device to enter a wireless pairing mode and to transmit the communication channel pairing message to the communication source device as identified by the communication source device address.

19. The communication destination device of claim 14, wherein:
the audio communication channel comprises an acoustic communication channel; and
the audio transceiver comprises a microphone.

20. The communication destination device of claim 19, wherein the pairing command comprises a media access control (MAC) address associated with the communication source device, the MAC address configured to initiate the communication destination device to enter a wireless pairing mode and to transmit the communication channel pairing message to the communication source device.

21. The communication destination device of claim 19, wherein the pairing command of the audio signal is operable to configure the communication destination device to enter a wireless pairing mode and to receive the communication channel pairing message from the communication source device.

22. The communication destination device of claim 21, wherein the wireless transceiver is configured to:
provide a wireless pairing mode timestamp associated with the communication destination devices; and
when receiving the communication channel pairing message from the communication source device to establish the wireless communication channel with the communication source device, receive the communication channel pairing message when the communication destination device has a wireless pairing mode timestamp that substantially matches a timestamp associated with the audio signal to establish the wireless communication channel with the communication source device.

23. The communication destination device of claim 21, wherein the wireless transceiver is configured to:
provide a signal strength associated with the communication destination device; and
when receiving the communication channel pairing message from the communication source device to establish the wireless communication channel with the communication source device, receive the communication channel pairing message from the communication source device when the signal strength provided by the communication destination device is greater than a signal strength associated with a second communication destination device.

24. The communication destination device of claim 21, wherein the wireless transceiver is configured to:
provide an identity indicator associated with the communication destination device; and
when receiving the communication channel pairing message from the communication source device to establish the wireless communication channel with the communication source device, receive the communication channel pairing message from the communication source device based upon the identity indicator associated with the communication destination device.

25. The communication destination device of claim 21, wherein:
the wireless transceiver is configured to provide a confirmation signal to the communication source device in response to reception of the audio signal by the microphone; and
the microphone is configured to receive a second audio signal from the communication source device via the audio communication channel in response to detection, by the communication source device, of an absence of the confirmation signal from the communication destination device.

26. The communication destination device of claim 19, wherein the audio transceiver is configured to:
when receiving the audio signal from the communication source device via the audio communication channel, receive a first audio signal from the communication source device via a first audio communication channel, the first audio signal including a first pairing command configured to initiate establishment of the wireless communication channel between the communication destination device and the communication source device; and
send a second audio signal to the communication source device via an audio communication channel, the second audio signal including a second pairing command configured to initiate establishment of a second wireless communication channel between the communication destination device and the communication source device.

27. The communication destination device of claim 13, wherein the audio transceiver is configured to one of receive or provide the audio signal, including the pairing command, in response to a power activation activity associated with the communication destination device.

28. The communication destination device of claim 13, wherein the audio transceiver is configured to one of receive or provide the audio signal, including the pairing command, in response to a disconnection from the previously-paired communication source device.

29. In a communication source device, a method of establishing a wireless communication channel with a communication destination device, comprising:
sending, by the communication source device, an audio signal to the communication destination device via an audio communication channel, the audio signal including a pairing command configured to initiate establishment of the wireless communication channel between the communication source device and the communication destination device; and
in response to sending the audio signal having the pairing command, one of:
(i) receiving, by the communication source device, a communication channel pairing message from the communication destination device, the communication channel pairing message configured to establish the wireless communication channel with the communication source device, and
(ii) sending, by the communication source device, a communication channel pairing message to the communication destination device to establish the wireless communication channel with the communication destination device.

30. In a communication destination device, a method of establishing a wireless communication channel with a communication source device, comprising:
receiving, by the communication destination device, an audio signal from the communication source device via an audio communication channel, the audio signal including a pairing command configured to initiate establishment of the wireless communication channel between the communication source device and the communication destination device; and
response to receiving the audio signal having the pairing command, one of:
(i) sending, by the communication destination device, a communication channel pairing message to the communication source device, the communication channel pairing message configured to establish the wireless communication channel with the communication destination device, and
(ii) receiving, by the communication destination device, a communication channel pairing message from the communication source device to establish the wireless communication channel with the communication source device.
